(19) United States
(12) Patent Application Publication
(10) Pub. No.: US 2010/0070880 A1
(43) Pub. Date: Mar. 18, 2010

(54) USER INTERFACE FOR IMPROVING THE USE OF NOTES WITH EMAIL MESSAGES THAT PROVIDES A STATIC VISUAL RELATIONSHIP BETWEEN NOTES AND EMAIL MESSAGES AND A NOTE INCORPORATION CAPABILITY

(75) Inventor: Kiran K. CHINTA, Beaverton, OR (US)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/212,152

(22) Filed: Sep. 17, 2008

(51) Int. Cl. G06F 15/16; G06F 3/048

(52) U.S. Cl. 715/752; 709/206

(57) ABSTRACT

The present invention can include an improved user interface for handling the note functionality of an enhanced note-enabled email system. Such an interface can include an email pane, a note pane, and a user-selectable note incorporation option. The email pane can be configured to execute various email and note commands of the enhanced note-enabled email system. The email pane can be presented within a software application window of the enhanced note-enabled email system. The note pane can be configured to create a static visual relationship between a user-selected email message of the email pane and an associated note of the note pane. The note pane can be presented separately and concurrently with the email pane. The user-selectable note incorporation option can be configured to trigger the incorporation of the note into the user-selected email message. Incorporation can occur prior to transmission of the user-selected email.

### BACKGROUND OF THE INVENTION

The present invention relates to the field of email annotation, and, more particularly, to a user interface that enables the incorporation of user-created notes into email messages.

The ability to create and associate annotation, also called notes, to email messages is covered in U.S. Published Application No. 2007/0239831 to Basu titled “Interface for Editing, Binding, and Displaying an Annotation for a Message”. However, the user interface described by the prior art is lacking in simplicity and functionality. The use of pop-up and/or fly-over windows to display and/or edit the note text makes it difficult for the user to maintain a visual relationship between the text of the note and the email message to which it corresponds. This lack of continuity quickly leads to user frustration and feature disuse.

Additionally, the interface described by U.S. Published Application No. 2007/0239831 does not provide the ability for a user to share their notes with other users. This deficiency seriously hinders the use of the note capability for collaborative efforts, which email, typically, plays a key role. Being able to selectively include or exclude note content from an email extends the usefulness of this feature.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 is a series of enhanced note-enabled email interfaces that improve the functionality of notes within email messages by providing a static visual relationship between notes and email messages and a note incorporation capability in accordance with embodiments of the inventive arrangements disclosed herein.

FIG. 2 is a schematic diagram illustrating a system for incorporating notes within email messages in accordance with embodiments of the inventive arrangements disclosed herein.

FIG. 3 is a flow chart of a method describing the incorporation of notes within email messages in accordance with an embodiment of the inventive arrangements disclosed herein.

### DETAILED DESCRIPTION OF THE INVENTION

The present invention discloses a solution that provides a user interface that improves the functionality of notes within email messages by providing a static visual relationship between notes and email messages and a note incorporation capability. This user interface can include an email pane and a note pane that share an application window. The note pane can remain in a fixed position within the application window, such that both the email and the note pane can be viewed concurrently. The note incorporation capability can allow the user to embed a user-created note into an email message.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

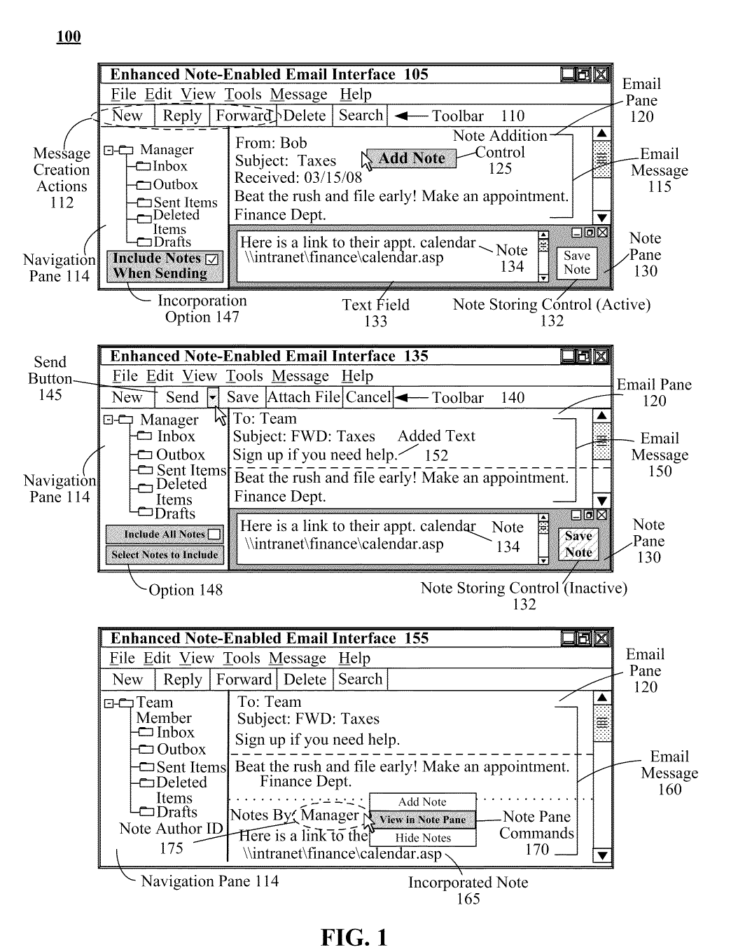

FIG. 1 is a series 100 of enhanced note-enabled email interfaces 105, 135, and 155 that improve the functionality of notes 134 within email messages 115 by providing a static visual relationship between notes and email messages and a note incorporation capability 147 in accordance with embodiments of the inventive arrangements disclosed herein. It should be noted that each enhanced note-enabled email interfaces 105, 135, and 155 can include a variety of additional visual components and functionality, and, as such, only those elements of particular note to the present invention are highlighted in series 100.

Each enhanced note-enabled email interfaces 105, 135, and 155 of the series 100 can illustrate key functionalities that are currently lacking in conventional email systems that utilize notes 134. Enhanced note-enabled email interface 105 can illustrate the establishment of a static visual relationship between a user-selected email message 115 and a user-created note 134.

In the enhanced note-enabled email interface 105, a user can view a selected email message 115 in the email pane 120. In one embodiment, the email message 115 can be one that has been selected from a set of messages presented within navigation pane 114. A dynamic relationship can exist among the different panes 114, 120, 130 so that content of changes dynamically to reflect user selections. That is, when a different email message is selected in the navigation pane 114, email content for that message is automatically presented in the email pane 120 and notes for that message are automatically presented in the note pane 130.

While viewing the email message 115, the user can decide to add a note 134 to the email message 115. When pre-existing notes exist, a new note can be added via the note pane 130, otherwise a first note can be added. A selection for adding a note, when the email message 115 does not already have one can cause the note pane (which can otherwise be hidden) to automatically appear in one embodiment of the invention.

The addition of the note 134 can be facilitated by a note addition control 125. The note addition control 125 can represent a user-selectable mechanism that allows the user to create a note 134 for the selected email message 115. The note addition control 125 can be implemented as a command of a toolbar 110 of the enhanced note-enabled email interface 105, and/or a menu command, such as the right-click menu shown in this example.

Upon execution of the note addition control 125, the note pane 130 can be launched within the enhanced note-enabled email interface 105. The concurrent yet distinct and separate display of the email 120 and note 130 panes establishes the static visual relationship between the email message 115 and the corresponding note 134. Because the note pane 130 remains stationary within the enhanced note-enabled email interface 105, the user can easily view both the email message 115 and the note 134 without interference or confusion.

The note pane 130 can include a text field 133 and a note storing control 132. The text field 133 can be the input mechanism that accepts the user-entered note 134. The note storing control 132 can be the means by which a user can initiate the storage of the note 134 by the email system supporting the enhanced note-enabled email interface 105. In this example, the user has just added the note 134, so the note storing control 132 can be shown in an active state to denote that it can be selected.

In addition to associating the note 134 with the email message 115, the storage mechanism for the note 134 can include capturing the user authoring the note 134 in the enhanced note-enabled email interface 105. The purpose of this enhancement to the storage mechanism can be seen later in the series 100.

In an alternate embodiment, the note pane 130 can be launched by a note addition control 125 from an email pane 120 displaying a listing of email messages, such as an inbox listing. Regardless of how the note pane 130 is launched, it should be emphasized that the note pane 130 can remain visible in a static location until a command is selected where the note pane 130 is not required. For example, the user can elect to view a different email message that does not have an associated note or the user can manually close the note pane 130.

Enhanced note-enabled email interface 135 can illustrate the resultant interface after a user has added/saved a note 134 to an email message 115 and selected a message creation action 112 from the toolbar 110. A message creation action 112, as shown in this example, can include a new email action, a reply to email action, including the reply-to-all version, and a forward email action. All of these actions 112 allow the user to add text 152 and send 145 the new email message 150.

The example shown in enhanced note-enabled email interface 135 illustrates the situation where the user has selected the message creation action 112 of ‘Forward’. Enhanced note-enabled email interface 135 can still include the email pane 120 and note pane 130, as well as a toolbar 140 of associated commands.

It is important to emphasize that the note pane 130 has remained in the same location from interface 105 to interface 135, and, still, displays the note 134 associated with the email message 150. Because email message 150 is derived from email message 115, the note 134 can continue to be displayed.

Since the user saved the note 134 in enhanced note-enabled email interface 105, the note storing control 132 of the note pane 130 in this example can be displayed in an inactive state. After completion of the storage action, the note storing control 132 can be deactivated until the user executes actions that warrant a reactivation, such as adding more text to the text field 133.

Alternately, the note storing control 132 can be removed from the note pane 130 to represent its inactive state and presented again when placed back into an active state.

In one embodiment, the save control 132 may not always be shown within the interface 105, 135. Instead, an option to save note changes can be automatically presented when a change is made to a note 134 and when a user performs an action to close a note window and/or to close the email message 115 associated with the note 134. Further, auto-saving features for notes 134 and/or messages 115 can be enabled for an email client.

When finished with the email message 150, the user can elect to transmit the email message 150 using the send button 145 or corresponding transmission mechanism. However, when an email message 150 has an associated note 134, the enhanced note-enabled email interface 135 can include a note incorporation option 147, 148.

The note incorporation option 147 can be a user-selectable mechanism that indicates that the associated note 134 is to be incorporated into the email message 150 when sent. The note incorporation option 147 can be implemented in a variety of ways, including, but not limited to, a check box, a radio button, a menu option, a toolbar 140 button, the drop-down menu option of this example, and the like. Note incorporation option 148 permits a user to select a portion of a set of notes to include when sending email messages. This option can require explicit selection of notes or can be based upon attributes associated with the notes. For example, a user can opt to select all notes 147 created by themselves, but to exclude all notes created by others when sending an email message 150.

It is important to emphasize that selection of the note incorporation option 147, 148 incorporates the note 134 into the email message 150; the note 134 is not simply added as an attachment or another file.

Upon sending the email message 150 with the note incorporation option 147, a recipient can view the resultant email message 160 in enhanced note-enabled email interface 155. Enhanced note-enabled email interface 155 can be similar to enhanced note-enabled email interface 105, in the sense that both users are viewing an email message 115 and 160 in the email pane 120. However, in the example shown by enhanced note-enabled email interface 155, the user is still viewing the email message 160. In one embodiment, the formatting of included notes can be such to ensure backwards compatibility with email client applications that lack note capabilities.

To support legacy email clients, the internal protocol design of the information may be changed. There could be numerous ways to achieve this goal, each of which is to be included within scope of the present invention. For example, when an enhanced note-enabled email client sends an email message including a note, then the note can be converted as an attachment internally and sent out to a client server. If the email is received by an enhanced note-enabled email client, then it can detect the note attachment as an original note and can convert the attachment to a note that is presented to the user within a note-enabled user interface. If the email is received by a legacy email client, then it is presented to the user as an attachment.

In another embodiment, a note can be included as an embedded comment contained in metadata and/or a discrete tagged section of an email message. A note-enabled email client can extract this metadata and handle it as a note, while a legacy email client can ignore it. An elaboration on this is to provide a plug-in module for legacy clients to automatically extract notes embedded in email messages and to convert each extracted notes into a standard attachment displayable within the legacy email client.

As shown in this example, the email message 160 includes all of the text from email messages 115 and 150 with the addition of the incorporated note 165. That is, the email message 160 can resemble the expected email message 160 generated by an enhanced note-enabled email system for the example course of actions.

The incorporated note 165 can display the note 134 shown in the note pane 130 of the previous interfaces 135 and 105 as well as an identifier of the note author 175. However, the incorporated note 165 can be presented within the body of the email message 160. This presentation of the incorporated note 165 can be a default configuration, capable of being changed by the user via note pane commands 170 and/or interface configuration options.

For example, a configuration option of the enhanced note-enabled email interface 105, 135, and 155 can automatically present the incorporated note 165 of email messages 160 in the note pane 130. Alternately, the user can select “View in Note Pane” from the menu of note pane commands 170, as shown in this example.

It should be noted that the presented functionality can be further applied in conjunction with other preexisting functionality of an email system and interface. For example, the note author ID 175 can be utilized by search functions to limit the scope of searches.

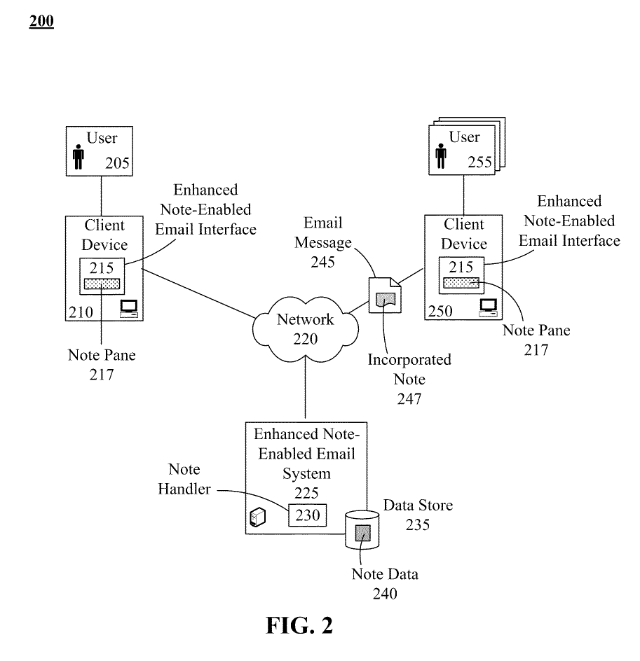

FIG. 2 is a schematic diagram illustrating a system 200 for incorporating notes 247 within email messages 245 in accordance with embodiments of the inventive arrangements disclosed herein. System 200 can utilize and/or implement the functionality of the enhanced note-enabled email interfaces 105, 135, and 155 of FIG. 1.

In system 200, a user 205 can send an email message 245 containing an incorporated note 247 to one or more other users 255 over a network 220. User 205 can utilize an enhanced note-enabled email interface 215, such as those illustrated in FIG. 1, operating on a client device 210. The client device 210 can represent any of a variety of computing devices capable of running the enhanced note-enabled email interface 215 and communicating with the enhanced note-enabled email system 225 over a network 220.

The enhanced note-enabled email interface 215 can be the means by which the user 205 can prepare an email message 245. The enhanced note-enabled email interface 215 can include a note pane 217 in which the user 205 can create/view notes. The user 205 can execute a command that indicates to the enhanced note-enabled email system 225 to incorporate the note into the sent email message 245.

The enhanced note-enabled email system 225 can represent the computing components required to support the functionality of the enhanced note-enabled email interface 215, such as a note handler 230 and a data store 235 of note data 240. When the enhanced note-enabled email system 225 is instructed to include notes with an email message 245, it can invoke the note handler 230.

The note handler 230 can be a component of the enhanced note-enabled email system 225 configured to incorporate the appropriate note data 240 into the email message 245. The note handler 230 can modify the electronic file containing the email message 245 to also include the incorporated note 247. The incorporated note 247 can be included within the file of the email message 245 in a separate section that allows the enhanced note-enabled email interface 215 to identify the note data 240 for presentation.

Upon successful incorporation of the note 247 into the email message 245, the enhanced note-enabled email system 225 can convey the email message 245 to the designated recipient users 255. The recipient users 255 can access the email message 245 with the incorporated note 247 using the enhanced note-enabled email interface 215 on their client devices 250.

As used herein, presented data stores, including store 240, can be a physical or virtual storage space configured to store digital information. Data store 240 can be physically implemented within any type of hardware including, but not limited to, a magnetic disk, an optical disk, a semiconductor memory, a digitally encoded plastic memory, a holographic memory, or any other recording medium. The data store 240 can be a stand-alone storage unit as well as a storage unit formed from a plurality of physical devices. Additionally, information can be stored within data store 240 in a variety of manners. For example, information can be stored within a database structure or can be stored within one or more files of a file storage system, where each file may or may not be indexed for information searching purposes. Further, data store 240 can utilize one or more encryption mechanisms to protect stored information from unauthorized access.

The network 220 can include any hardware/software/firmware necessary to convey digital content encoded within carrier waves. Content can be contained within analog or digital signals and conveyed through data or voice channels and can be conveyed over a personal area network (PAN), a local area network (LAN), or a wide area network (WAN). The network 220 can include local components and data pathways necessary for communications to be exchanged among computing device components and between integrated device components and peripheral devices. The network 220 can also include network equipment, such as routers, data lines, hubs, and intermediary servers which together form a packet-based network, such as the Internet or an intranet. The network 220 can further include circuit-based communication components and mobile communication components, such as telephony switches, modems, cellular communication towers, and the like. The network 220 can include line based and/or wireless communication pathways.

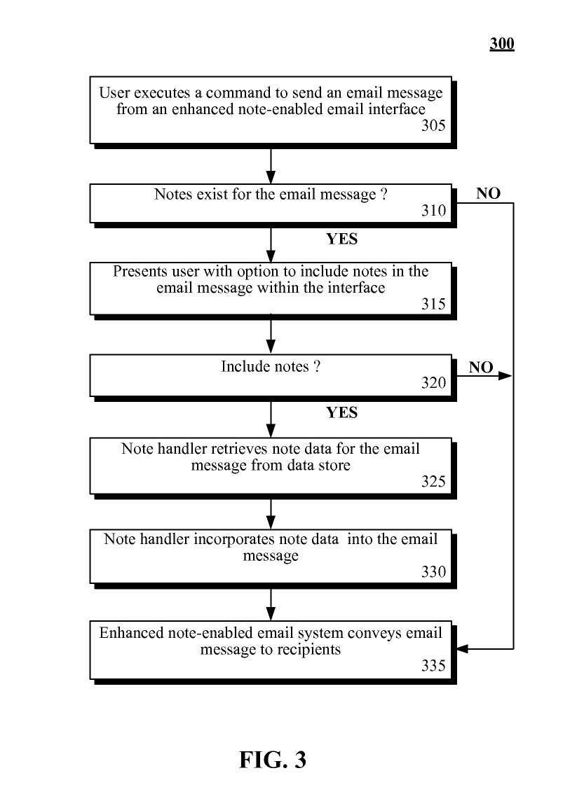

FIG. 3 is a flow chart of a method 300 describing the incorporation of notes within email messages in accordance with an embodiment of the inventive arrangements disclosed herein. Method 300 can be performed in the context of system 200 and/or utilizing the enhanced note-enabled email interfaces 105, 135, and/or 155 of FIG. 1.

Method 300 can begin in step 305 where a user can execute a command to send an email message from an enhanced note-enabled email interface. In step 310, the enhanced note-enabled email interface can determine if notes exist for the current email message.

When notes do not exist for the email message, flow can proceed to step 335 where the enhanced note-enabled email system can convey the email message to its recipients. When notes do exist for the email message, the user can be presented with the option to include the notes in the email message within the enhanced note-enabled email interface in step 315.

In step 320, the enhanced note-enabled email system can determine if the user has elected to include the notes in the email message. When the user does not want to include the notes in the email message, flow can proceed to step 335 where the enhanced note-enabled email system can convey the email message to its recipients.

When the user wants to include the notes in the email message, step 325 can execute where the note handler retrieves the note data for the email message from the data store. The note handler can incorporate the note data into the email message in step 330. In step 335, the enhanced note-enabled email system can convey the email message to its recipients.

While method 300 shows an implementation where a user is prompted to include/exclude notes after a send command for an associated email message is issued by a user. The invention is not to be limited in this regard and other implementations are contemplated.

For example, in one embodiment, a user can be given an option in a preferences menu of an email application such as “check for inclusion of notes at the time of sending an email message” that has user configurable values of yes, no, or prompt. When this option is set to “yes” steps 315 and 320 can be skipped and the method 300 can proceed directly from step 315 to step 325. When the option is set to “no” the method 300 can proceed directly from step 305 to step 335, skipping steps 310-330. When the option is set to “prompt” the method 300 can proceed as diagrammed.

In another contemplated embodiment, prompting for notes can occur on a note specific basis, where a user can select one or more notes to include in the sent message and can choose to exclude one or more notes when sending the message. In another variation, a preferences menu can permit a user to establish rules and conditions for handling an inclusion/exclusion of notes that can vary based upon variables such as recipient identity, email type, note type, email and note content, and other such factors.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for incorporating user-created notes within an email message comprising:
identifying, via a processor executing a computer program product, a user-selection of an option, which selectively includes and excludes a set of at least one stored note embedded within an email message, when that email message is being copied for conveyance to at least one recipient;
when the option indicates that the set of at least one note is to be included, conveying, via a processor executing a computer program product, a copy of the email message having the embedded at least one stored note to the at least one recipient; and
when the option indicates that the set of at least one note is to be excluded, creating, via a processor executing a computer program product, a new copy of the email message, where the new copy does not include the at least one stored note, conveying the new copy of the email message to the at least one recipient.

2. The method of claim 1, wherein the at least one stored note comprises a plurality of stored notes, said method further comprising:
Identifying, via a processor executing a computer program product, a user selection to include a first portion of the plurality of stored notes when conveying the email message to said at least one recipient and to exclude a second portion of the plurality of stored notes when conveying the email message to said at least one recipient,
conveying the copy of the email message having the first portion only of the stored notes embedded within the email message.

3. The method of claim 1, further comprising:
creating, via a processor executing a computer program product, the email message within a note-enabled graphical user interface, said graphical user interface comprising an email pane configured to visually present email content of at least one email message, wherein said email content includes an email title, an email subject, and content in a body of the email message and a note pane configured to visually present at least one note associated with the email message presented in the email pane, wherein the note pane is presented separately and concurrently with the email pane within the software application window, wherein the email pane and the note pane are different, persistent panes of a graphical user interface window of a note-enabled email system, wherein said set of at least one note is presented within the email pane at a time a user selection to send an email message is made from the graphical user interface, and wherein the identified option is presented within the graphical user interface.

4. The method of claim 1, further comprising:
presenting, via a processor executing a computer program product, the copy of the email message within a note-enabled graphical user interface, said graphical user interface comprising an email pane configured to visually present email content of at least one email message, wherein said email content includes an email title, an email subject, and content in a body of the email message and a note pane configured to visually present the set of at least one note associated with the email message that is presented in the email pane, wherein the note pane is presented separately and concurrently with the email pane within the software application window, wherein the email pane and the note pane are different, persistent panes of a graphical user interface window of a note-enabled email system.

5. A computer program product for incorporating user-created notes within an email message comprising:
a computer usable medium having computer usable program code embodied therewith, the computer usable program code comprising:
computer usable program code configured to identify of a user-selection of an option, which selectively includes and excludes a set of at least one stored note embedded within an email message, when that email message is being copied for conveyance to at least one recipient;
computer usable program code configured to, when the option indicates that the set of at least one note is to be included, convey a copy of the email message having the embedded at least one stored note to the at least one recipient; and
computer usable program code configured to, when the option indicates that the set of at least one note is to be excluded, create a new copy of the email message, where the new copy does not include the at least one stored note, conveying the new copy of the email message to the at least one recipient.

6. The computer program product of claim 5, wherein the at least one stored note comprises a plurality of stored notes, said method further comprising:
computer usable program code configured to identify a user selection to include a first portion of the plurality of stored notes when conveying the email message to said at least one recipient and to exclude a second portion of the plurality of stored notes when conveying the email message to said at least one recipient, conveying the copy of the email message having the first portion only of the stored notes embedded within the email message.

7. The computer program product of claim 5, further comprising:
computer usable program code configured to create the email message within a note-enabled graphical user interface, said graphical user interface comprising an email pane configured to visually present email content of at least one email message, wherein said email content includes an email title, an email subject, and content in a body of the email message and a note pane configured to visually present at least one note associated with the email message presented in the email pane, wherein the note pane is presented separately and concurrently with the email pane within the software application window, wherein the email pane and the note pane are different, persistent panes of a graphical user interface window of a note-enabled email system, wherein said set of at least one note is presented within the email pane at a time a user selection to send an email message is made from the graphical user interface, and wherein the identified option is presented within the graphical user interface.

8. The computer program product of claim 5, further comprising:
computer usable program code configured to present the copy of the email message within a note-enabled graphical user interface, said graphical user interface comprising an email pane configured to visually present email content of at least one email message, wherein said email content includes an email title, an email subject, and content in a body of the email message and a note pane configured to visually present the set of at least one note associated with the email message that is presented in the email pane, wherein the note pane is presented separately and concurrently with the email pane within the software application window, wherein the email pane and the note pane are different, persistent panes of a graphical user interface window of a note-enabled email system.

9. The method of claim 1, wherein each of said set of at least one note is an annotation to an email message associated with the email message, wherein each of said set of at least one note is distinct from the email message and handled within a separate pane of an email interface from a pane that handles the email message.

10. The computer program product of claim 5, wherein each of said set of at least one note is an annotation to an email message associated with the email message, wherein each of said set of at least one note is distinct from the email message and handled within a separate pane of an email interface from a pane that handles the email message.
